(19) United States
(12) Patent Application Publication
(10) Pub. No.: US 2025/0373002 A1
(43) Pub. Date: Dec. 4, 2025

(54) ELECTRICAL CIRCUIT FOR ELECTRICAL SAFETY

(71) Applicant: Blixt Tech AB, Kista (SE)

(72) Inventor: Jan JOHANSSON, Solna (SE)

(73) Assignee: Blixt Tech AB, Kista (SE)

(21) Appl. No.: 18/876,207

(22) PCT Filed: Apr. 18, 2023
(86) PCT No.: PCT/EP2023/060019

§ 371 Date: Dec. 18, 2024

(30) Foreign Application Priority Data
Jun. 20, 2022 (SE) 2250744-6

(51) Int. Cl. H02H 3/16

(52) U.S. Cl. CPC H02H 3/16

(57) ABSTRACT

The invention relates to an electrical circuit for electrical safety. The electrical circuit comprises an input configured to be connected to a power supply; an output configured to be connected to a load; a current delay circuit and a first switching device connected in series between the input and the output; and a second switching device connected between the first switching device and a ground. The electrical circuit is configured to operate in: a first mode in which the first switching device is in its conductive state thereby feeding a first current to the load and the second switching device is in its non-conductive state; a second mode, following the first mode, in which the first switching device is in its conductive state thereby feeding a first current to the load and the second switching device is in its conductive state thereby feeding a second current to the ground; and a third mode, following the second mode, in which the first switching device is in its non-conductive state and the second switching device is in its conductive state. The invention also relates to a system and a corresponding method.

### TECHNICAL FIELD

The invention relates to an electrical circuit for electrical safety. The invention also relates to a system and a corresponding method.

### BACKGROUND

Residual current circuit breakers (RCCBs) or residual current devices (RCDs) are well known in the art. Other terms for devices with the corresponding function are ground fault circuit interrupter, ground fault interrupter, appliance leakage current interrupter, and leakage current detection interrupter.

The purpose of such devices such as RCCBs and RCDs is to quickly break or disconnect an electrical circuit to prevent harm to persons from electrical shock when the current is not balanced between the supply conductor and return conductor. In this respect, such devices generally apply galvanic isolation.

Usually, RCCBs and RCDs are testable and resettable devices. Mechanical input means such as a test button creates a small leakage condition, and a reset button reconnects the conductors after a fault condition has been cleared.

### SUMMARY

An objective of embodiments of the invention is to provide a solution which mitigates or solves the drawbacks and problems of conventional solutions.

Another objective of embodiments of the invention is to provide an alternative solution to galvanic isolation for electrical safety.

The above and further objectives are solved by the subject matter of the independent claims. Further advantageous embodiments of the invention can be found in the dependent claims.

According to a first aspect of the invention, the above mentioned and other objectives are achieved with an electrical circuit for electrical safety, the electrical circuit comprising:
an input configured to be connected to a power supply;
an output configured to be connected to a load;
a current delay circuit and a first switching device connected in series between the input and the output; and
a second switching device connected between the first switching device and a ground; wherein the electrical circuit is configured to operate in:
a first mode in which the first switching device is in its conductive state thereby feeding a first current to the load and the second switching device is in its non-conductive state;
a second mode, following the first mode, in which the first switching device is in its conductive state thereby feeding a first current to the load and the second switching device is in its conductive state thereby feeding a second current to the ground; and
a third mode, following the second mode, in which the first switching device is in its non-conductive state and the second switching device is in its conductive state.

That a switching device in the present disclosure is in its conductive state is understood that a current can pass through the switching device when in its conductive state, which also may be denoted an active state, an ON state, an ON mode, etc. Hence, when the switching device is in its non-conductive state, no current can pass the switching device. The non-conductive state can also be denoted a non-active state, an OFF state, an OFF mode, etc.

The electrical circuit according to the first aspect provides an alternative solution to galvanic isolation for electrical safety. Therefore, the present electrical circuit solves the problem of guaranteeing personal electrical safety without galvanic isolation.

In an implementation form of an electrical circuit according to the first aspect, the current delay circuit is configured to control the switching of the first switching device.

An advantage with this implementation form is that the electrical circuit can be set in a so-called safe mode when the first switching device is controlled by or via the current delay circuit.

In an implementation form of an electrical circuit according to the first aspect, the current delay circuit is configured to control the switching of the first switching device via a control line.

In an implementation form of an electrical circuit according to the first aspect, the control line comprises an AND logic connected to the current delay circuit and a control device.

In an implementation form of an electrical circuit according to the first aspect, the current delay circuit is configured to switch the first switching device into its non-conductive state when a current at the current delay circuit is larger than a threshold current.

An advantage with this implementation form is that the electrical circuit can be set in its safe mode according to or in dependence of a threshold current or a corresponding threshold voltage. Hence, the threshold current may be considered as a design parameter when designing the electrical circuit.

In an implementation form of an electrical circuit according to the first aspect, the current delay circuit comprises an inductor.

In an implementation form of an electrical circuit according to the first aspect, wherein the current delay circuit is configured control the first switching device based on a threshold voltage at a node between the first switching device and the inductor, wherein the threshold voltage corresponds to the threshold current.

An advantage with this implementation form is that it is possible to detect a threshold voltage corresponding to the threshold current before the current increases to dangerous levels in the circuit by switching the first switching device into its non-conductive state.

In an implementation form of an electrical circuit according to the first aspect, the current delay circuit comprises a first resistance connected in parallel to the inductor, and a second resistance connected in series with the first resistance and the inductor.

An advantage with this implementation form is that the threshold current can be designed according to the values of the first and second resistances, respectively.

In an implementation form of an electrical circuit according to the first aspect, the first resistance is larger than the second resistance.

In an implementation form of an electrical circuit according to the first aspect, the current delay circuit is connected between the input and the first switching device or between the first switching device and the output.

In an implementation form of an electrical circuit according to the first aspect, the second switching device is configured to switch between its conductive state and non-conductive state based on a control signal.

In an implementation form of an electrical circuit according to the first aspect, the second switching device comprises at least one controllable electronic switch.

The electronic/electrical switch can be a transistor, such as a field effect transistor, which means that the switching time is much faster than the switching time of mechanical switches.

In an implementation form of an electrical circuit according to the first aspect, the second switching device comprises a mechanical switch connected in parallel with the controllable electronic switch.

An advantage with this implementation form is that extra personal safety is provided with the mechanical switch in parallel with the electronic switch. Further, the electronical switch can switch fast so that no person will be harmed by electrical shock. The mechanical switch may however fulfil regulatory requirements, e.g., stipulated by national law and governmental agencies.

In an implementation form of an electrical circuit according to the first aspect, the mechanical switch is configured to be in its conductive state when no voltage is applied at the mechanical switch.

An advantage with this implementation form is extra personal safety since the second switching device will always be connected to ground via the mechanical switch as long as no voltage is applied.

In an implementation form of an electrical circuit according to the first aspect, the first switching device comprises at least one controllable electronic switch.

In an implementation form of an electrical circuit according to the first aspect, the first switching device, the output and the second switching device are connected to a common node.

In an implementation form of an electrical circuit according to the first aspect, the ground is an earth ground or a reference ground.

According to a second aspect of the invention, the above mentioned and other objectives are achieved with a system comprising a first electrical circuit and at least one second electrical circuit according to any one of the preceding implementation forms, wherein the first electrical circuit is connected to a neutral output of the power supply and the second electrical circuit is connected to a phase output of the power supply, and wherein the system is configured to operate the first electrical circuit and the second electrical circuit synchronously.

The neutral output as wells as the phase output can be considered as a floating voltage for the electrical circuit. Hence, an advantage with the system according to the second aspect is that personal safety can be guaranteed even when the electrical circuit is connected to a neutral output and a phase output, respectively, with a floating voltage.

According to a third aspect of the invention, the above mentioned and other objectives are achieved with a method for controlling an electrical circuit for electrical safety, the electrical circuit comprising: an input configured to be connected to a power supply; an output configured to be connected to a load; a current delay circuit and a first switching device connected in series between the input and the output; and a second switching device connected between the first switching device and a ground; the method comprising:
operating the electrical circuit in a first mode in which the first switching device is in its conductive state thereby feeding a first current to the load and the second switching device is in its non-conductive state;
operating the electrical circuit in a second mode, following the first mode, in which the first switching device is in its conductive state thereby feeding a first current to the load and the second switching device is in its conductive state thereby feeding a second current to the ground; and
operating the electrical circuit in a third mode, following the second mode, in which the first switching device is in its non-conductive state and the second switching device is in its conductive state.

The method according to the third aspect can be extended into implementation forms corresponding to the implementation forms of the electrical circuit according to the first aspect. Hence, an implementation form of the method comprises the feature(s) of the corresponding implementation form of the electrical circuit.

The advantages of the methods according to the third aspect are the same as those for the corresponding implementation forms of the electrical circuit according to the first aspect.

Further applications and advantages of the embodiments of the invention will be apparent from the following detailed description.

### BRIEF DESCRIPTION OF THE DRAWINGS

The appended drawings are intended to clarify and explain different embodiments of the invention, in which:

FIG. 1 shows the architecture of an electrical circuit according to an embodiment of the invention;

FIGS. 2a-2c show the electrical circuit operating in different modes according to an embodiment of the invention;

FIG. 3 shows an electrical circuit according to further embodiments of the invention;

FIGS. 4 and 5 show a first switching device connected to and controlled by a current limiting circuit according to further embodiments of the invention;

FIG. 6 shows a current limiting circuit according to further embodiments of the invention;

FIG. 7 shows a second switching device according to further embodiments of the invention;

FIG. 8 shows a system according to embodiments of the invention; and

FIG. 9 shows a flow chart of a method according to embodiments of the invention.

### DETAILED DESCRIPTION

As aforementioned, RCCBs and RCDs according to conventional solutions are based on galvanic isolation of electrical circuits. However, such solutions with galvanic isolation are slow to react which means that the current can raise to dangerous or lethal levels for humans. Further, galvanic isolation can also be costly to implement especially for solutions aiming at shortening the reaction time of the galvanic isolation. Therefore, it is herein disclosed and provided an alternative solution to galvanic isolation for personal safety thus without the need for galvanic isolation.

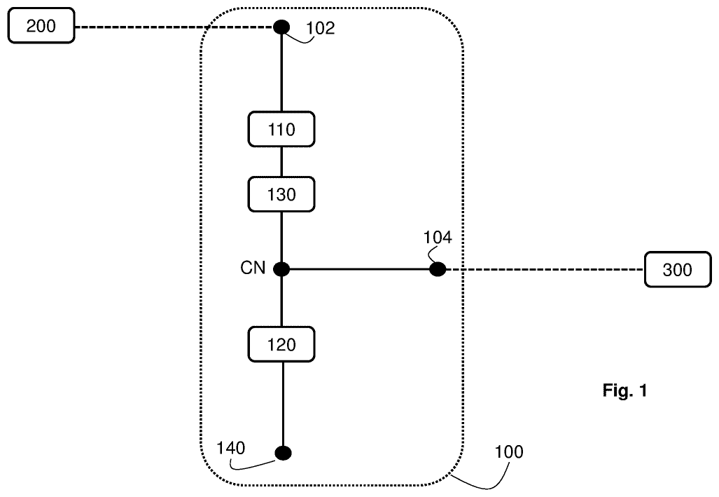

FIG. 1 shows the architecture of an electrical circuit 100 according to embodiments of the invention. The electrical circuit 100 comprises an input 102 configured to be connected to a power supply 200. The electrical circuit 100 further comprises an output 104 configured to be connected to a load 300. The electrical circuit 100 further comprises a first switching device 110 connected between the input 102 and the output 104. The electrical circuit 100 further comprises a current delay circuit 130 connected in series with the first switching device 110. The current delay circuit 130 and the first switching device 110 are connected between the input 102 and the output 104. The electrical circuit 100 further comprises a second switching device 120 connected between the first switching device 110 and a ground 140. In embodiments of the invention, the current delay circuit 130, the first switching device 110, the output 104 and the second switching device 120 are connected to a common node CN as was also shown in FIG. 1. It may be noted that the current delay circuit 130 may be connected between the input 102 and the first switching device 110 or between the first switching device 110 and the output 104 as long as the current delay circuit 130 is coupled in series with the first switching device 110.

The power supply 200 is configured to feed or deliver an alternating current (AC) or a direct current (DC) to the load 300 depending on application and the load. Only one load 300 is shown in FIG. 1 but it is realized that more than one load can be connected to the electrical circuit 100 and fed with AC or DC current. The power supply 200 may be any electrical power source delivering AC or DC power/current. The load 300 may be any electrical power consumer configured to consume AC or DC power directly or via a power storage device such as batteries or capacitors.

In embodiments of the invention, the mentioned ground is earth ground. This may be understood that the electrical circuit may be connected to the potential of the earth, hence have the same potential as the earth. In other embodiments of the invention, the ground is instead a reference ground for an electrical system which has a potential different to the potential of the earth. Such a reference ground may e.g., be found in vehicles or in any other designs and constructions conductively isolated from the earth.

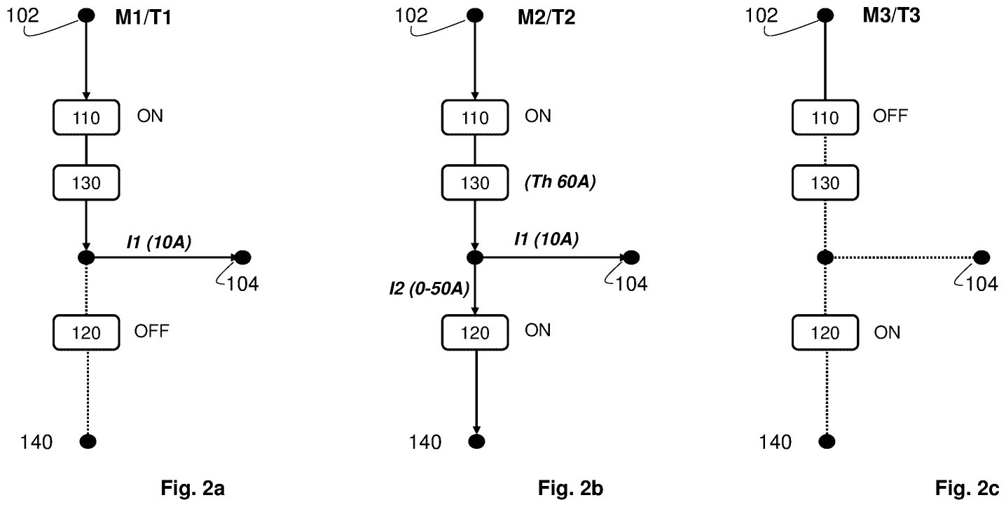

FIGS. 2a-2c show different operating modes of the electrical circuit 100 according to embodiments of the invention.

In FIG. 2a, the electrical circuit 100 operates in its first mode M1 in which the first switching device 110 is in its conductive state (ON) thereby a first current i1 is fed by the electrical circuit 100 to the load 300 and the second switching device 120 is in its non-conductive state (OFF) meaning that there is no conductive connection to the ground 140 in this mode. The electrical circuit 100 operates in the first mode M1 during a first time period T1. In the disclosed non-limiting example, the value of the first current i1 feed to the load 300 has been set to 10A for illustrative purpose.

In FIG. 2b, the electrical circuit 100 operates in its second mode M2, following the first mode M1. In the second mode M2, the first switching device 110 is still in its conductive state (ON) thereby the electrical circuit 100 feeding a first current i1 to the load 300 while the second switching device 120 is activated and has switched to its conductive state (ON) from its non-conductive state (OFF) thereby the electrical circuit 100 also feeding/providing a second current i2 to the ground 140. The electrical circuit 100 operates in the second mode M2 during a second time period T2 directly following the first time period T1. During the second time period T2, the first current it is still 10A while the second current i2 raises from 0A to 50A during a transitory time interval e.g., due to the raise time of the conductivity of controllable electrical switches. Hence, when the second switching device 120 is set in its conductive state the current from the power supply 200 will increase to the ground 140 in the electrical circuit 100 during the second time period T2. The current delay circuit 130 will however delay the increase of the current in the electrical circuit 100 so that suitable measures may be taken in the next operating mode of the electrical circuit 100.

In FIG. 2c, the electrical circuit 100 operates in its third mode M3 following the second mode M2. In the third mode M3, the first switching device 110 is fully switched from its conductive state (ON) into its non-conductive state (OFF) while the second switching device 120 is still in its conductive state (ON) hence conductively connected to ground 140. The electrical circuit 100 operates in the third mode M3 during a third time period T3 directly following the second time period T2. With the switching configuration of the third mode M3 no current can run from the power supply 120 to the load 300 since the first switching device 110 is in its non-conductive mode.

The third mode M3 may in embodiments of the invention be triggered if the current at the current delay circuit 130 reaches a current threshold value denoted Th_{c}. For example, in the illustrated example in FIGS. 2a-2c the threshold is set to Th_{c}=60A i.e., when the sum of i1 and 2 is equal to i1=10 and i2=50. This will be explained more in detail in the following disclosure.

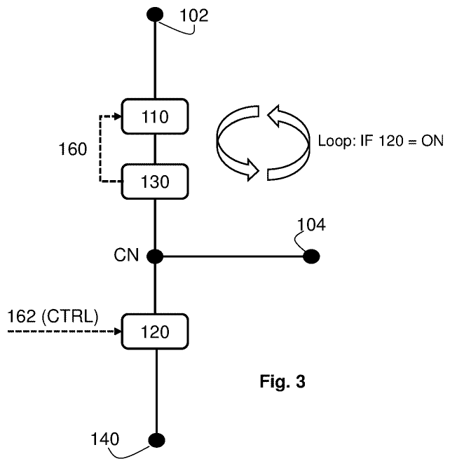

FIG. 3 shows an electrical circuit 100 according to embodiments of the invention in which the first switching device 110 is controlled by or via the current delay circuit 130. The latter case may be understood as that the first switching device 110 is configured to be controlled based on a voltage/current at the current delay circuit 130. In this respect, the first switching device 110 may be connected to the current delay circuit 130 via an electrical control line 160 known in the art. The current delay circuit 130 and/or an associated control device may be configured to control the switching of the first switching device 110 according to different aspects of the invention.

In embodiments of the invention, the current delay circuit 130 is configured to switch the first switching device 110 from its conductive state into its non-conductive state when a current at the current delay circuit 130 is larger than the threshold current Th_{c}. The threshold current Th_{c} can however be translated to a corresponding threshold voltage Thᵥ. In such case, a corresponding voltage at the current delay circuit 130 is monitored and the first switching device 110 will be set or switched into its non-conductive state if the monitored voltage exceeds a threshold voltage Thᵥ corresponding to the current threshold Th_{c}. The voltage in an electrical circuit increases before the current increase which means that suitable actions can be taken before the current reaches dangerous levels. The relationship between the voltage and the current at the current delay circuit 130 can e.g., be derived from Ohm's law.

The above configuration also implies that if the electrical circuit 100 is set in its safe mode, the first switching device 110 will be switched back to its non-conductive state every time the first switching device 110 is switched into its conductive state when the second switching device 120 is in its conductive state since there will be a current running through the electrical circuit 100 to ground 140. Hence, the first switching device 110 may be set in a safe mode loop as long as the second switching device 120 is connected to the ground 140. Thus, as long as the circuit 100 is in its safe mode, i.e., second switching device 120 connected to ground 140, the first switching device 110 can be switched ON any number of times without the risk of electrical shock and personal harm. The safe mode of the electrical circuit 100 is a very safe alternative to galvanic isolation.

The above-described safe mode configuration also means that the electrical circuit 100, or rather the first 110 and second 120 switching devices, can be controlled with a single external control signal applied at the second switching device 120 since the voltage/current at the current delay circuit 130 will always reach the threshold value when the second switching device 120 is in its conductive state connecting the electrical circuit 100 to ground 140. In other words, the second switching device 120 may be configured to switch between its conductive state and non-conductive state based on a control signal 162 from e.g., a control device 170.

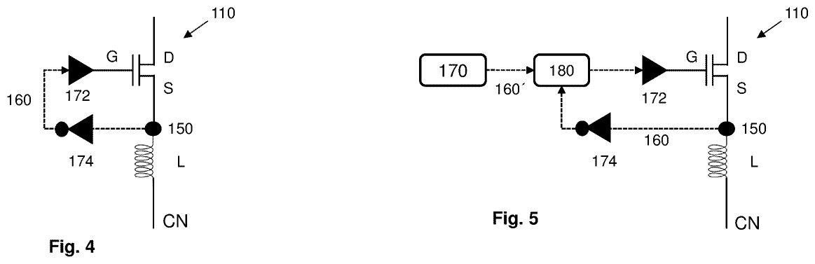

FIGS. 4 and 5 show the first switching device 110 controlled by or via the current limiting circuit 130 according to two different embodiments of the invention. FIG. 4 discloses the example when first switching device 110 is directly controlled by the current limiting circuit 130 whilst FIG. 5 discloses the example when the first switching device 110 is controlled by the current limiting circuit 130 together with a control device 170 providing an external control signal 160′. In both non-limiting examples, the current delay circuit 130 comprises an inductor L and the first switching device 110 is exemplified as a transistor having a gate G, a drain D, and a source S. The drain D of the transistor is connected to the input 102, the source S of the transistor is connected to first node 150 at the current delay circuit 130 and the gate G of the transistor, which is used to control the transistor, is connected to a control line 160 connecting the gate G of the transistor to the current delay circuit 130. The inductor L has a first connection point connected to the first node 150 and a second connection point connected to the common node CN of the electrical circuit 100. Furthermore, the first switching device 110, in this case exemplified as a transistor, is controlled based on a threshold voltage at the first node 150 located between the first switching device 110 and the inductor L of the current delay circuit 130.

In FIG. 4 when a voltage at the first node 150 exceeds the threshold voltage, the first switching device 110 will be set in its OFF mode by applying the voltage at the first node 150 at the gate G pin of the transistor via an inverter 174 and a driver 172. For N-MOS transistors when a negative voltage is applied at the gate G pin, the transistor is switched off, hence the inverter 174 in the circuit shown in FIG. 4. However, the transistor could be of a P-MOS type for which the contrary holds, i.e., the transistor is switched off when a positive voltage is applied. The driver 172 amplifies the received signal with a current amplification so that the transistor switches to its OFF mode.

FIG. 5 on the other hand shows the example when the first switching device 110 is controlled further based on an external control signal 160′ from a control device 170. The control device 170 and the first node 150 are connected to respective inputs of an AND block/logic 180. The first node 150 is however connected to the AND block 180 via an inverter 174 if the transistor is of N-MOS type as previously explained. The output of the AND block 180 is further connected to the gate G pin via a driver 172 which amplifies the current. When the voltage at the first node 150 exceeds the threshold voltage and at the same time an activation control signal is applied by the control device 170, a common control signal will be applied at the gate G of the transistor which will switch the transistor into its non-conductive state.

The control device 170 can be any of a software solution, a hardware solution or a combination of software and hardware. For example, as a software solution the control means can be implemented in a microcontroller whilst in a hardware solution the control means can be implemented in physical logical circuits.

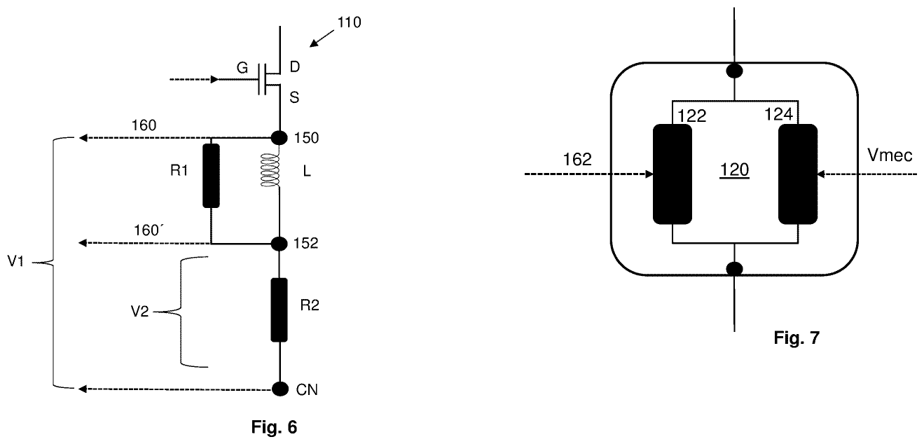

FIG. 6 shows a current limiting circuit 130 according to further embodiments of the invention in which the current delay circuit 130 comprises a first resistance R1 connected in parallel to the inductor L. The current delay circuit 130 also comprises a second resistance R2 connected in series with the first resistance R1 and the inductor L. Thereby, the voltage will be divided over the first resistance R1 and the second resistance R2 in the current delay circuit 130. By selecting suitable values of R1 and R2 the threshold voltage and hence the corresponding threshold current can be designed to suitable values, e.g., L=3 micro Henry, R1=99 milli Ohm, and R2=1 milli Ohm. Generally, the first resistance R1 is larger or much larger than the second resistance R2 since the inductance should be able to delay the raise of the current in the electrical circuit 100 which therefore should pass over the inductance and not over the first resistance R1.

Further, two different voltages may be considered in the design in FIG. 6. The first voltage V1 defines the potential difference between the first node 150 of the current delay circuit 130 and the common node CN. The first voltage V1 may be used to control the first switching device 110 without any voltage amplification since if the first resistance R1 has a large value, the voltage at the first node 150 will increase to a high value. However, a current amplification may be needed to switch the transistor into its OFF state e.g., by the use of a driver 172. The second voltage V2 on the other hand defines a potential difference between a second node 152 of the current delay circuit 130 located between the inductor L and the second resistance R2 and the common node CN. The second voltage V2 may be used to control the first switching device 110 however with an intermediate voltage amplification.

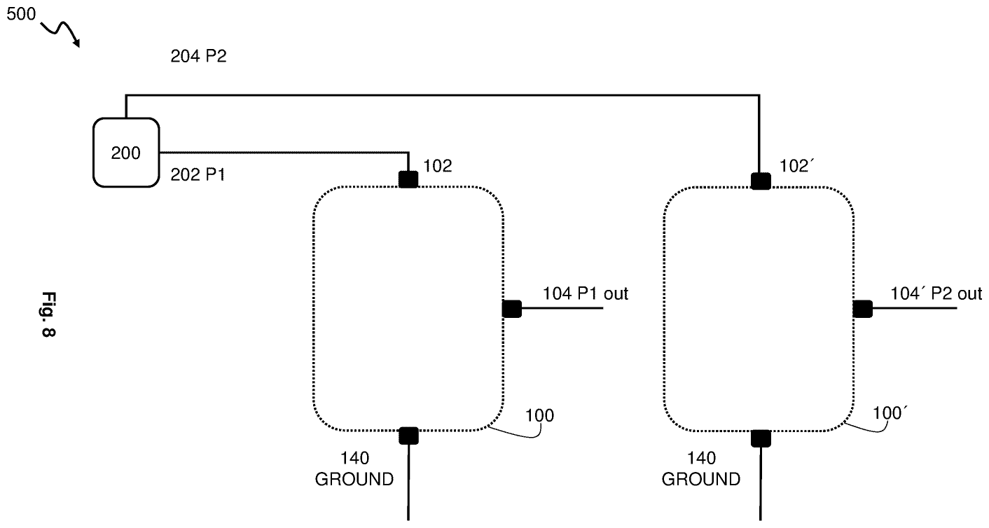

FIG. 7 shows a second switching device 120 according to embodiments of the invention in which the second switching device 120 comprises an electronic switch 122, such as a transistor, controlled with a control signal 162. Further, the second switching device 120 may further comprise a mechanical switch 124 connected in parallel with the electronic switch 122. Hence, the electrical circuit 100 will be connected to ground 140 if any of the electronic switch 122 or the mechanical switch 124 is in its conductive state. The electronic switch 122 has a very short response time while the mechanical switch 124 on the other hand has a longer response time in comparison. This implies that the mechanical switch 124 will be set in its conductive state after the electronic switch 122 if they are activated with the same activation signal or with two different activation signals activated at the same time instance. Therefore, in embodiments the mechanical switch 124 and the electronic switch 122 are activated at the same time instance which may also be the case at deactivation.

For improved personal safety the mechanical switch 124 may in embodiments be configured to be in its conductive state when no voltage, i.e., Vmec in FIG. 7, is applied at the mechanical switch 124. This means that the second switching device 120 will always be connected to the ground 140 via the mechanical switch 124 if no power/voltage is applied. Hence, the electrical circuit 100 in a powerless state will be set in its safe mode if the first switching device 110 is controlled by a threshold current/voltage at the current delay circuit 130.

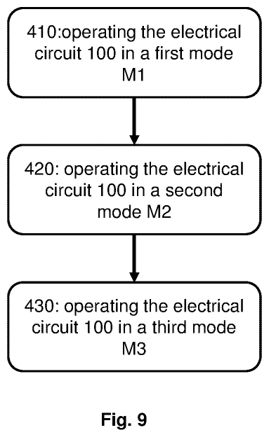

FIG. 8 shows a system according to embodiments of the invention. As shown in FIG. 8, the system 500 comprises a first electrical circuit 100 and at least one second electrical circuit 100′ according to embodiments of the invention. The first electrical circuit 100 is connected to a first phase P1 output 210 of the power supply 200 while the second electrical circuit 100′ is connected to a second phase P2 output 220 of the power supply 200. It is noted that first electrical circuit 100 and a second electrical circuit 100′ are connected to a common ground 140.

The system 500 in FIG. 8 may be configured to operate the first electrical circuit 100 and the second electrical circuit 100′ synchronously meaning that the switching devices of the first electrical circuit 100 and the second electrical circuit 100′ are controlled coordinated and synchronously. Thereby, the present solution can with its advantages also be implemented in systems using floating ground where the first phase P1 and the second phase P2 are floating and can vary.

FIG. 9 shows a flow chart of a method according to embodiments of the invention. The herein disclosed method is for controlling an electrical circuit 100 as previously described. The method 400 comprises operating 410 the electrical circuit 100 in a first mode M1 in which the first switching device 110 is in its conductive state thereby the electrical circuit 100 feeding a first current i1 to the load 300 and the second switching device 120 is in its non-conductive state. The method 400 further comprises operating 420 the electrical circuit 100 a second mode M2, following the first mode M1, in which the first switching device 110 is in its conductive state thereby the electrical circuit 100 feeding a first current i1 to the load 300 and the second switching device 120 is in its conductive state thereby the electrical circuit 100 feeding a second current i2 to the ground 140. The method 400 further comprises operating 430 the electrical circuit 100 a third mode M3, following the second mode M2, in which the first switching device 110 is in its non-conductive state and the second switching device 120 is in its conductive state.

Finally, it should be understood that the invention is not limited to the embodiments described above, but also relates to and incorporates all embodiments within the scope of the appended independent claims.

1. An electrical circuit for electrical safety, the electrical circuit comprising:
an input configured to be connected to a power supply;
an output configured to be connected to a load;
a current delay circuit and a first switching device connected in series between the input and the output; and
a second switching device connected between the first switching device and a ground;
wherein the electrical circuit is configured to operate in:
a first mode in which the first switching device is in its conductive state thereby feeding a first current to the load and the second switching device is in its non-conductive state;
a second mode, following the first mode, in which the first switching device is in its conductive state thereby feeding a first current to the load and the second switching device is in its conductive state thereby feeding a second current to the ground; and
a third mode, following the second mode, in which the first switching device is in its non-conductive state and the second switching device is in its conductive state.

2. The electrical circuit according to claim 1, wherein the current delay circuit is configured to control the switching of the first switching device.

3. The electrical circuit according to claim 1, wherein the current delay circuit is configured to control the switching of the first switching device via a control line.

4. The electrical circuit according to claim 3, wherein the control line comprises an AND logic connected to the current delay circuit and a control device.

5. The electrical circuit according to claim 2, wherein the current delay circuit is configured to switch the first switching device into its non-conductive state when a current at the current delay circuit is larger than a threshold current.

6. The electrical circuit according to claim 1, wherein the current delay circuit comprises an inductor.

7. The electrical circuit according to claim 6, wherein the current delay circuit is configured control the first switching device based on a threshold voltage at a node between the first switching device and the inductor, wherein the threshold voltage corresponds to the threshold current.

8. The electrical circuit according to claim 6, wherein the current delay circuit comprises a first resistance connected in parallel to the inductor, and a second resistance connected in series with the first resistance and the inductor.

9. The electrical circuit according to claim 8, wherein the first resistance is larger than the second resistance.

10. The electrical circuit according to claim 1, wherein the current delay circuit is connected between the input and the first switching device or between the first switching device and the output.

11. The electrical circuit according to claim 1, wherein the second switching device is configured to switch between its conductive state and non-conductive state based on a control signal.

12. The electrical circuit according to claim 1, wherein the second switching device comprises at least one controllable electronic switch.

13. The electrical circuit according to claim 12, wherein the second switching device comprises a mechanical switch connected in parallel with the controllable electronic switch.

14. The electrical circuit according to claim 13, wherein the mechanical switch is configured to be in its conductive state when no voltage is applied at the mechanical switch.

15. The electrical circuit according to claim 1, wherein the first switching device comprises at least one controllable electronic switch.

16. The electrical circuit according to claim 1, wherein the first switching device, the output and the second switching device are connected to a common node.

17. The electrical circuit according to claim 1, wherein the ground is an earth ground or a reference ground.

18. A system comprising the electrical circuit according to claim 1, wherein the electrical circuit is connected to a neutral output of the power supply and a second electrical circuit is connected to a phase output of the power supply, and wherein the system is configured to operate the electrical circuit and the second electrical circuit synchronously.

19. A method for controlling an electrical circuit for electrical safety, the electrical circuit comprising: an input configured to be connected to a power supply; an output configured to be connected to a load; a current delay circuit and a first switching device connected in series between the input and the output; and a second switching device connected between the first switching device and a ground; the method comprising:
operating the electrical circuit in a first mode in which the first switching device is in its conductive state thereby feeding a first current to the load and the second switching device is in its non-conductive state;
operating the electrical circuit in a second mode, following the first mode, in which the first switching device is in its conductive state thereby feeding a first current to the load and the second switching device is in its conductive state thereby feeding a second current to the ground; and
operating the electrical circuit in a third mode, following the second mode, in which the first switching device is in its non-conductive state and the second switching device is in its conductive state.
